(19) United States
(12) Patent Application Publication
(10) Pub. No.: US 2012/0116764 A1
(43) Pub. Date: May 10, 2012

(54) Speech recognition method on sentences in all languages

(76) Inventors: Tze Fen Li, Taichung (TW); Tai-Jan Lee Li, Taichung (TW); Shih-Tzung Li, Taichung (TW); Shih-Hon Li, Taichung (TW); Li-Chuan Liao, Taichung (TW)

(21) Appl. No.: 12/926,301

(22) Filed: Nov. 9, 2010

(51) Int. Cl. G10L 15/04

(52) U.S. Cl. 704/251; 704/E15.001

(57) ABSTRACT

A speech recognition method on all sentences in all languages is provided. A sentence can be a word, name or sentence. All sentences are represented by E×P=12×12 matrices of linear predict coding cepstra (LPCC) 1000 different voices are transformed into 1000 matrices of LPCC to represent 1000 databases. E×P matrices of known sentences after deletion of time intervals between two words are put into their closest databases. To classify an unknown sentence, use the distance to find its F closest databases and then from known sentences in its F databases, find a known sentence to be the unknown one. The invention needs no samples and can find a sentence in one second using Visual Basic. Any person without training can immediately and freely communicate with computer in any language. It can recognize up to 7200 English words, 500 sentences of any language and 500 Chinese words.

### BACKGROUND OF THE INVENTION

1. Field of the Invention

The invention can recognize sentences in all languages. A sentence can be a syllable, a word, a name or a sentence. The feature of this invention is to transform all sentences in any language into “equal-sized E×P=12×12 matrices” of linear predict coding cepstra (LPCC) using E=12 equal-sized elastic frames (window) The prior speech recognition methods have to compute and compare the feature values (a series of E×P matrices of words) of a whole sentence, but the invention only computes and compares a 12×12 matrix of LPCC for the sentence.

First, M=1000 different voices are pronounced and after deletion of noise and time intervals without real signal points, transformed into 1000 different matrices of LPCC which represent 1000 different databases. A known sentence is clearly uttered and all noise and time intervals without language signal points, before and after the known sentence, between two syllables and two words, are deleted. After deletion, all real signal points left are transformed by E=12 equal elastic frames into an E×P matrix of linear predict coding cepstra (LPCC) The E×P matrices of LPCC of all known sentences are put into their most similar databases individually. The invention does not use samples. The invention can recognize the sentences as soon as the sentences are input into their most similar databases.

To classify an unknown sentence, after deletion of all noise and time intervals without language signal points, all real signal points left in the unknown sentence are transformed by the E equal elastic frames into an E×P matrix of LPCC. Use a distance method to find its F most similar databases and then from the known sentences in the F most similar databases, find a known sentence to be the unknown one.

After pronunciation of a sentence, the invention can immediately and accurately find the sentence in less than one second using Visual Basic. The speech recognition method in the invention is simple and does not need samples. Any person can use the invention without training or practice to immediately and freely communicate with a computer in any language. It can recognize a large amount of words up to 7200 English words, 500 sentences in all languages and 500 Chinese words.

2. Description of the Prior Art

Usually, to classify an unknown sentence, first, the unknown sentence has to be partitioned into words. The segmentation of an unknown sentence into words is a high and tough skill. An unknown sentence has one to many words and a word may have many syllables. A mistake of segmentation on any one syllable will lead to a wrong sentence. After the partition of the unknown sentence into unknown words, all unknown words of the unknown sentence must be compared with all known words in the database of known words. A mistake in finding wrong known word will lead again to a wrong sentence. Finally, the known words are linked into a known sentence according to the order of the unknown words in the unknown sentence and then find a known sentence in the sentence database to be the unknown one. It is difficult to classify an unknown sentence by the prior speech recognition methods. The prior speech recognition methods on sentences need samples to make a word database, take much more time for computation and use statistics in classification. The statistical estimation does not give an accurate recognition. Hence, it is impossible to use the prior speech recognition methods to freely and immediately communicate with a computer.

In the recent years, many speech recognition devices with limited capabilities are now available commercially. These devices are usually able to deal only with a small number of acoustically distinct words. The ability to converse freely with a machine still represents the most challenging topic in speech recognition research. The difficulties involved in speech recognition are:

(1) to extract linguistic information from an acoustic signal and discard extra linguistic information such as the identity of the speaker, his or her physiological and psychological states, and the acoustic environment (noise),

(2) to normalize an utterance which is characterized by a sequence of feature vectors that is considered to be a time-varying, nonlinear response system, especially for an English words which consist of a variable number of syllables,

(3) to meet real-time requirement since prevailing recognition techniques need an extreme amount of computation, and

(4) to find a simple model to represent a speech waveform since the duration of waveform changes every time with nonlinear expansion and contraction and since the durations of the whole sequence of feature vectors and durations of stable parts are different every time, even if the same speaker utters the same words or syllables.

These tasks are quite complex and would generally take considerable amount of computing time to accomplish. Since for an automatic speech recognition system to be practically useful, these tasks must be performed in a real time basis. The requirement of extra computer processing time may often limit the development of a real-time computerized speech recognition system.

A speech recognition system basically contains extraction of a sequence of feature for a word or a sentence, normalization of the sequence of features such that the same words (sentences) have their same feature at the same time position and different words (sentences) have their different own features at the same time position, segmentation of a sentence or name into a set of words and selection of a matching sentence or name from a database to be the sentence or name pronounced by a user.

The measurements made on speech waveform include energy, zero crossings, extrema count, formants, linear predict coding cepstra (LPCC) and Mel frequency cepstrum coefficient (MFCC) The LPCC and the MFCC are most commonly used in most of speech recognition systems. The sampled speech waveform can be linearly predicted from the past samples of the speech waveform. This is stated in the papers of Markhoul, John, Linear Prediction: A tutorial review, Proceedings of IEEE, 63(4) (1975), Li, Tze Fen, Speech recognition of mandarin monosyllables, Pattern Recognition 36 (2003) 2713-2721, Li, Tze Fen, Apparatus and Method for Normalizing and Categorizing Linear Prediction Code Vectors using Bayesian Categorization Technique, U.S. Pat. No. 5,704,004, Dec. 30, 1997 and in the book of Rabiner, Lawrence and Juang, Biing-Hwang, Fundamentals of Speech Recognition, Prentice Hall PTR, Englewood Cliffs, N.J., 1993. The LPCC to represent a word provides a robust, reliable and accurate method for estimating the parameters that characterize the linear, time-varying system which is recently used to approximate the nonlinear, time-varying response system of the speech waveform. The MFCC method uses the bank of filters scaled according to the Mel scale to smooth the spectrum, performing a processing that is similar to that executed by the human ear. For recognition, the performance of the MFCC is said to be better than the LPCC using the dynamic time warping (DTW) process in the paper of Davis, S. B. and Mermelstein, P., Comparison of parametric representations for monosyllabic word recognition in continuously spoken sentences, IEEE Trans. Acoustic Speech Signal Process, ASSP-28(4), (1980), 357-366, but in the recent research, the LPCC gives a better recognition than the MFCC by the use of the Bayesian classifier with much less computation time. There are several methods used to perform the task of utterance classification. A few of these methods which have been practically used in automatic speech recognition systems are dynamic time warping (DTVV) pattern matching, vector quantization (VQ) and hidden Markov model (HMM) method. The above recognition methods give good recognition ability, but their methods are very computational intensive and require extraordinary computer processing time both in feature extraction and classification. Recently, the Bayesian classification technique tremendously reduces the processing time and gives better recognition than the HMM recognition system. This is given by the papers of Li, Tze Fen, Speech recognition of mandarin monosyllables, Pattern Recognition 36 (2003) 2713-2721, Li, Tze Fen, Apparatus and Method for Normalizing and Categorizing Linear Prediction Code Vectors using Bayesian Categorization Technique, U.S. Pat. No. 5,704,004, Dec. 30, 1997 and Chen, Y. K., Liu, C. Y., Chiang, G. H. and Lin, M. T., The recognition of mandarin monosyllables based on the discrete hidden Markov model, The 1990 Proceedings of Telecommunication Symposium, Taiwan, 1990, 133-137, but the feature extraction and compression procedures, with a lot of experimental and adjusted parameters and thresholds in the system, of the time-varying, nonlinear expanded and contracted feature vectors to an equal-sized pattern of feature values representing a word for classification are still complicated and time consuming. The main defect in the above or prior speech recognition systems are that their systems use many arbitrary, artificial or experimental parameters or thresholds, especially using the MFCC feature. These parameters or thresholds must be adjusted before their systems are put in use. Furthermore, the existing speech recognition systems are not able to identify any utterance in a fast or slow speech, which limits the recognition applicability and reliability of their systems.

Therefore, there is a need to find a speech recognition system, which can freely and friendly communicate with a machine (a computer)

### SUMMARY OF THE PRESENT INVENTION

One object of the invention is to a speech recognition method on sentences in all languages. A sentence can be a syllable, a word, a name or a sentence. The feature of this invention is to transform all sentences in any language into the “equal-sized E×P=12×12 matrices” of linear predict coding cepstra (LPCC) using E=12 equal-sized elastic frames (window) without filter and without overlap.

First, 1000 different voices are pronounced and after deletion of noise and time intervals without real signal points, transformed into 1000 different matrices of LPCC which represent 1000 different databases. A known sentence is clearly uttered and all noise and time intervals without language signal points, before and after the known sentence, between two syllables and two words, are deleted. After deletion, all signal sampled points left are transformed by E equal elastic frames into an E×P matrix of LPCC. The E×P matrices of LPCC of all known sentences are put into their most similar databases individually. The invention does not use samples. The invention can recognize the sentences as soon as the sentences are put into their most similar databases.

To classify an unknown sentence, after deletion of all noise and time intervals without language signal points, all signal sampled points left of the unknown sentence are transformed by the E equal elastic frames into an E×P matrix of LPCC. Use a distance method to find its F most similar databases and then from the known sentences in its F most similar databases, find a known sentence to be the unknown one.

The prior speech recognition methods have to compute and compare a series of matrices of features of words for a whole sentence, but the present invention only computes and compares one E×P matrix of LPCC for the sentence. After pronunciation of a sentence, the invention will immediately and accurately find the sentence in less than one second using Visual Basic. The speech recognition method in the invention is simple and does not need samples. Any person can use the invention without training or practice to immediately and freely communicate with a computer in any language. It can recognize a large amount of words up to 7200 English words, 500 sentences in any language and 500 Chinese words.

The above and other objects, features and advantages of the invention will become apparent from the following detailed description taken with the accompanying drawings.

### BRIEF DESCRIPTION OF THE DRAWINGS

A sentence can be a syllable, a word, a name or a sentence in any language. First, M=1000 different voices are prepared to represent 1000 databases.

FIG. 1 is a flow-chart diagram to build M=1000 different databases, each having similar known sentences with pronunciations similar to the voice to represent the database;

FIG. 2 is the flow-chart diagram showing the processing steps of speech recognition on unknown sentences;

FIGS. 3-5 show speech recognition on English and Chinese sentences; and

FIGS. 6 and 7 show the input of Chinese characters by the invention.

### DETAILED DESCRIPTION OF THE PREFERRED EMBODIMENT

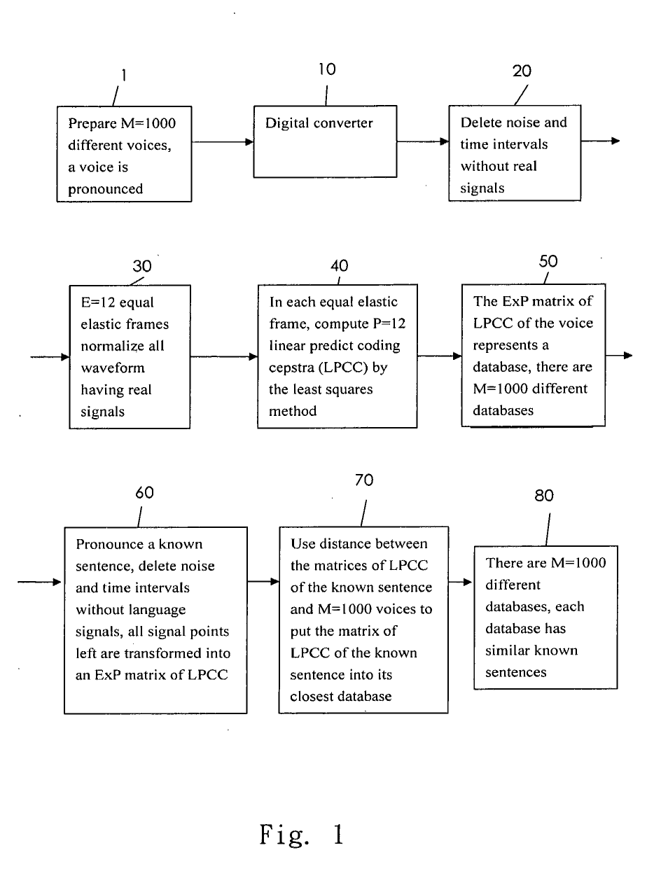

Referring to FIG. 1, a speech recognition method on sentences in all languages is illustrated. A sentence can be a syllable, a word, a name or a sentence consisting of several words in any language. First prepare M=1000 different voices 1. Digital converter 10 converts the waveform of a voice (sentence) into a series of digital sampled signal points. A preprocessor 20 after receiving the series of digital signals from the digital converter 10 deletes noise and all time intervals without digital real signals, before and after a voice (sentence), between two syllables and two words in a sentence. Then the total length of the new waveform with real signals denoting the voice (sentence) is equally partitioned into E=12 “equal” segments by E equal elastic frames (windows) 30 without filter and without overlap. Since the length of each equal frame is proportional to the total length of the waveform denoting the voice (sentence), the E equal frames are called E equal elastic frames which can stretch and contract themselves to cover the whole waveforms of variable length for the voice (sentence) Each voice or each sentence has the same number E of equal elastic frames without filter and without overlap to cover its waveform, i.e., a voice (sentence) with a short waveform has less sampled points in an equal frame and a voice (sentence) with a long waveform has more sampled points in an equal frame. The E equal frames are plain and elastic without Hamming or any other filter and without overlap, contracting themselves to cover the short voice (sentence) waveform produced by the short pronunciation of a voice (sentence) and stretching themselves to cover the long waveform produced by long pronunciation of a voice (sentence), without the need of deleting or compressing or warping the sampled points or feature vectors as in the dynamic time-warping matching process and in the existent pattern recognition systems. After equal partition on the waveform with E equal elastic frames 30 without filter and without overlap to cover the waveform, the sampled signal points in each equal frame are used to compute the P=12 least squares estimates of regression coefficients, since a sampled point of voice (sentence) waveform is linearly dependent of the past sampled points by the paper of Makhoul, John, Linear Prediction: A tutorial review, Proceedings of IEEE, 63(4) (1975) The 12 least squares estimates in a frame are called 12 linear predict coding coefficients (a LPC vector), which are then converted into P=12 more stable linear predict coding cepstra (a LPCC vector of dimension P) 40. The E×P matrix of LPCC (E LPCC vectors) of a voice represents a database and hence there are 1000 different databases 50. Pronounce a known sentence, delete noise and time intervals without language signal points, before and after the known sentence, between two syllables and between two words, and all sampled signal points left are transformed into an E×P matrix of LPCC 60. Use a distance method between the matrices of LPCC of the known sentence and M=1000 different voices to find their closest databases and put the E×P matrices of LPCC of the known sentences into their closest databases 70. There are 1000 different databases, each having similar known sentences 80.

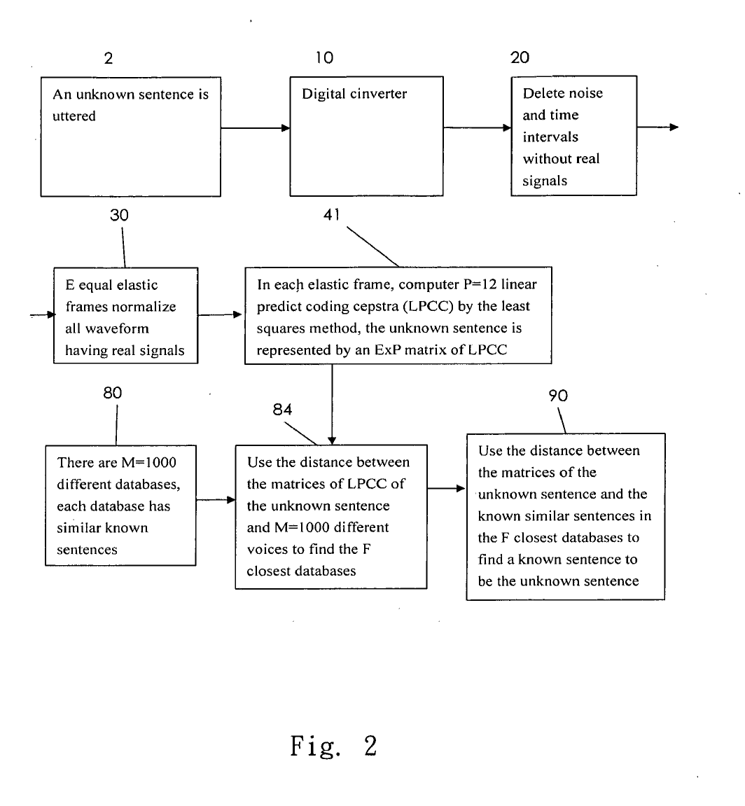

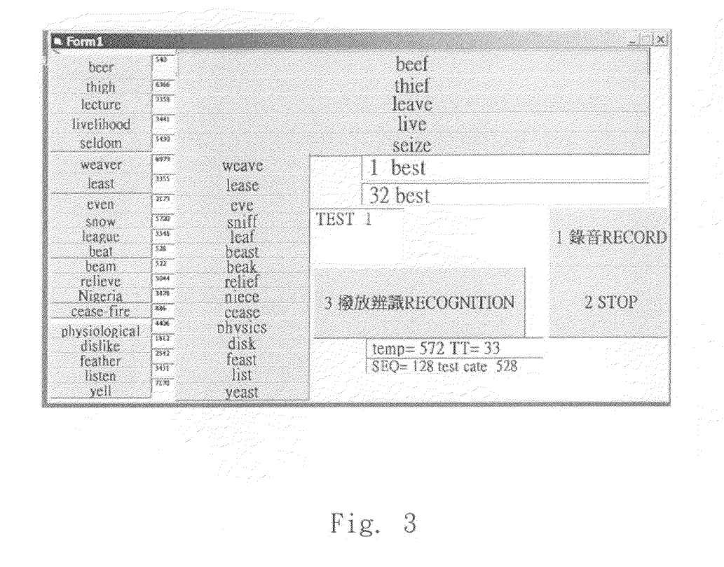

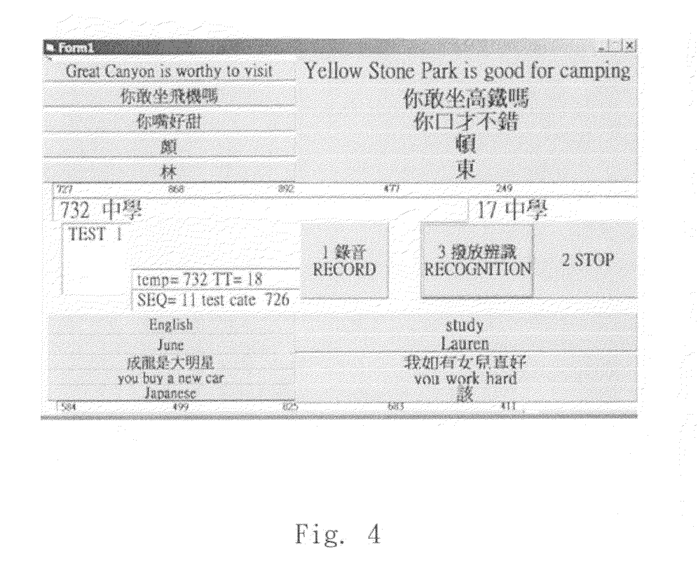

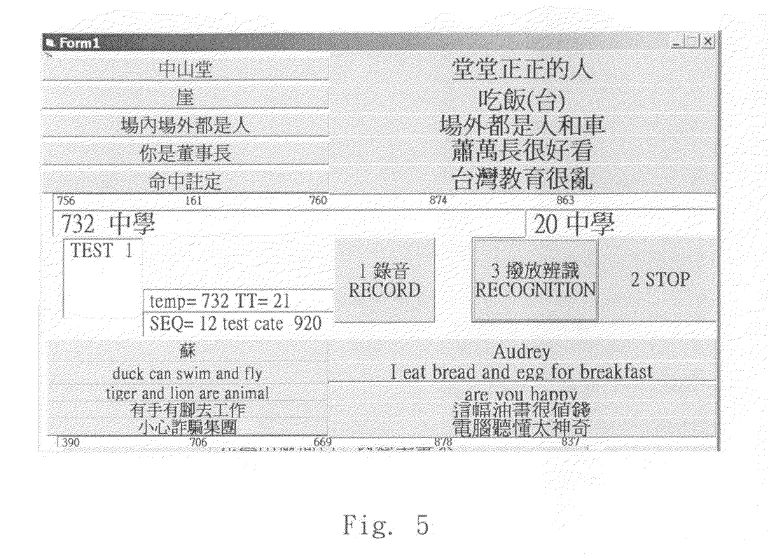

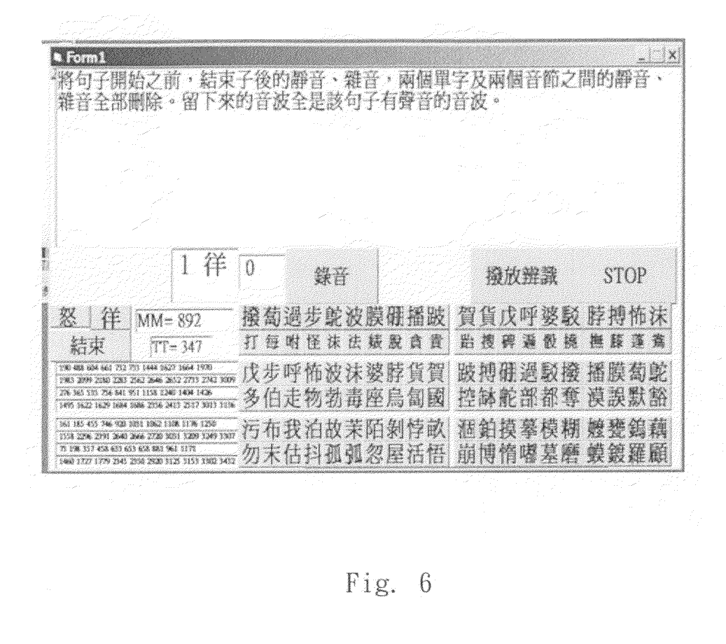

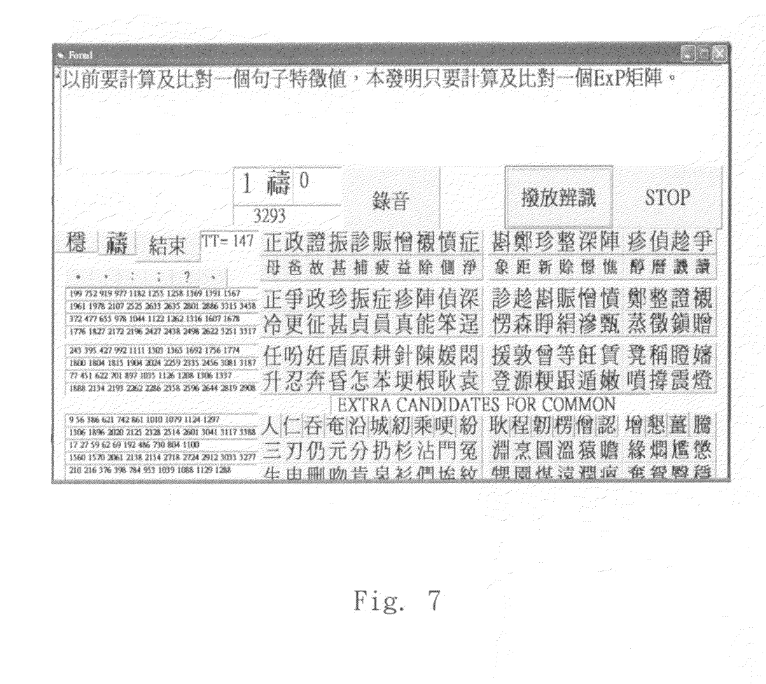

Referring to FIG. 2, the invention recognizes an unknown sentence. An unknown sentence is uttered 2. A digital converter converts the waveform of the unknown sentence into a series of digital signal points 10 and a preprocesser deletes noise and time intervals without language signal points, before and after the unknown sentence, between two syllables and two words 20. E=12 equal elastic frames (window) without filter and without overlap normalize the whole waveform of language signal points of the unknown sentence 30. In each equal elastic frame, the least squares method computes P=12 linear predict coding cepstra and an E×P matrix of linear predict coding cepstra (LPCC) represents the unknown sentence 41. Use the distance (weighted distance) between the E×P matrix of LPCC of the unknown sentence and the matrices of LPCC of M=1000 different voices 80 to find its F closest databases 84 and again use the distance (weighted distance) between the E×P matrix of LPCC of the unknown sentence and the matrices of LPCC of the known sentences in its F closest databases to find a known sentence to be the unknown sentence 90. As follows is the detailed description of the present invention:

1. The invention needs M=1000 different voices 1. After a voice or a sentence is pronounced, the voice (sentence) is converted into a series of signal sampled points by a digital converter 10. Then delete noise and time intervals without real digital signal points, before and after the voice (sentence), between two syllables and two words in a sentence 20. The invention provides two methods. One is to compute the sample variance in a small segment of sampled points. If the sample variance is less than that of noise, delete the segment. Another is to calculate the total sum of absolute distances between two consecutive points in a small segment. If the total sum is less than that of noise, delete the segment. From experiments, two methods give about the same recognition rate, but the latter is simple and time-saving.

2. After delete the sampled points which do not have real signal points, the whole series of sampled points are equally partitioned into a fixed number E=12 of equal segments, i.e., each segment contains the same number of sampled points. E equal segments form E windows which do not have filters and do not overlap each other. E equal segments are called E “equal” elastic frames since they can freely contract or expand themselves to cover the whole voice (sentence) waveform. The number of the signal sampled points in an equal elastic frame is proportional to the total signal sampled points of a voice (sentence) waveform 30.

3. The signal sampled points in each equal elastic frame are transformed into the P=12 least squares estimates. Since in the paper of Markhoul, John, Linear Prediction: A Tutorial Review, Proceedings of the IEEE, 63(4), 1975, the sampled signal point S(n) can be linearly predicted from the past sampled points, a linear approximation S′ (n) of S(n) can be formulated as:

$${S}^{′} ( n ) = {\sum }_{k = 1}^{P} {a}_{k} S ( n - k ) , n \geq 0 \qquad ( 1 )$$

where P is the number of the past samples and the least squares estimates aₖ, k=1, . . . , P, are generally referred to be the linear predict coding coefficients (a LPC vector) The LPC method (the least squares method) provides a robust, reliable and accurate method for estimating the linear regression parameters that characterize the linear, time-varying regression system which is used to approximate the nonlinear, time-varying system of the waveform of a voice (sentence) Hence, in order to have a good estimation of the nonlinear time-varying system by the linear regression models, the invention uses an equal segmentation on the whole waveform into E=12 small equal segments. Each equal segment is called an elastic frame 30. There are E equal elastic frames without filter and without overlap which can freely contract or expand themselves to cover the whole waveform of the voice (sentence) Let E₁ be the squared difference between S(n) and S′(n) over N+1 samples of S(n), n=0, 1, 2, . . . , N, where N is the number of sampled points in a frame proportional to the length of a whole speech waveform denoting a voice (sentence), i.e.,

$${E}_{1} = {\sum }_{n = 0}^{N} {[ S ( n ) - {\sum }_{k = 1}^{P} {a}_{k} S ( n - k ) ]}^{2} \qquad ( 2 )$$

To minimize E₁, taking the partial derivative for each i=1, . . . , P on the right side of (2) and equating it to zero, we obtain the set of normal equations:

$${\sum }_{k = 1}^{P} {a}_{k} {\sum }_{n} S ( n - k ) S ( n - i ) = {\sum }_{n} S ( n ) S ( n - i ) , 1 \leq i \leq P \qquad ( 3 )$$

Expanding (2) and substituting (3), the minimum total squared error, denoted by E_{P} is shown to be

$${E}_{P} = {\sum }_{n} {S}^{2} ( n ) - {\sum }_{k = 1}^{P} {a}_{k} {\sum }_{n} S ( n ) S ( n - k ) \qquad ( 4 )$$

Eq (3) and Eq (4) then reduce to

$$\begin{matrix}{\sum }_{k = 1}^{P} {a}_{k} R ( i - k ) = R ( i ) , 1 \leq i \leq P & ( 5 ) \\ {E}_{P} = R ( 0 ) - {\sum }_{k = 1}^{P} {a}_{k} R ( k ) & ( 6 )\end{matrix}$$

respectively; where

$$R ( i ) = {{\sum }_{n = 0}}^{N - i} S ( n ) S ( n + i ) , i \geq 0 \qquad ( 7 )$$

Durbin's recursive procedure, in the book of Rabiner, L. and Juang, Biing-Hwang, Fundamentals of Speech Recognition, Prentice Hall PTR, Englewood Cliffs, N.J., 1993, can be specified as follows:

$$\begin{matrix}{E}_{0} = R ( 0 ) & ( 8 ) \\ {k}_{i} = [ R ( i ) - {\sum }_{j = 1}^{i - 1} {a}_{j}^{( i - 1 )} R ( i - j ) ] / {E}_{i - 1} & ( 9 ) \\ {a}_{i}^{( i )} = {k}_{i} & ( 10 ) \\ {a}_{j}^{( i )} = {a}_{j}^{( i - 1 )} - {k}_{i} {a}_{i - j}^{( i - 1 )} , 1 \leq j \leq i - 1 & ( 11 ) \\ {E}_{i} = ( 1 - {k}_{i}^{2} ) {E}_{i - 1} & ( 12 )\end{matrix}$$

Eq (8)-(12) are solved recursively for i=1, 2, . . . , P. The final solution (LPC coefficient or least squares estimate) is given by

aⱼ=aⱼ^{(P)}, 1≦j≦P (13)

The P LPC coefficients are then transformed into P more stable linear predict coding cepstra (LPCC) âᵢ, i=1, . . . , P 40, in Rabiner and Juang's book, by

$$\begin{matrix}{\hat{a}}_{i} = {a}_{i} + {\sum }_{j = 1}^{i - 1} ( \frac{j}{i} ) {a}_{i - j} {\hat{a}}_{j} , 1 \leq i \leq P & ( 14 ) \\ {\hat{a}}_{i} = {\sum }_{j = i - P}^{i - 1} ( \frac{j}{i} ) {a}_{i - j} {\hat{a}}_{j} , P < i & ( 15 )\end{matrix}$$

Here in our experiments, P=12, because the cepstra in the last few elements are almost zeros. The whole waveform of the voice (sentence) is transformed into an E×P matrix of LPCC, i.e., a voice (sentence) is denoted by an E×P matrix of linear predict coding cepstra 50.

4. The E×P matrix of LPCC of a voice represents a database 50. There are M=1000 different databases. A known sentence is converted into a series of signal sampled points. Delete noise and all time intervals without language signal points, before and after the known sentence, between two syllables and two words. The signal sampled points left are transformed by 12 equal elastic frames and the least squares method into an E×P matrix of LPCC to denote the known sentence 60.

5. Use the distance or weighted distance between the E×P matrix of LPCC of the known sentence and the 1000 different E×P matrices of M=1000 different voices representing 1000 different databases to find the closest database and the matrix of LPCC of the known sentence is put into the closest database 70. There are 1000 databases and each has similar known sentences 80.

6. To classify an unknown sentence 2, the unknown sentence is converted into a series of signal sampled points 10. Delete noise and all time intervals without language signal points, before and after the unknown sentence, between two syllables and two words 20. The whole real signal sampled points of the unknown sentence are transformed by 12 equal elastic frames 30 and by the least squares method into an E×P matrix of linear predict coding cepstra (LPCC) 41.

7. To classify the unknown sentence, the invention uses the distance or weighted distance between the E×P matrix of LPCC of the unknown sentence and 1000 different E×P matrices of 1000 voices representing 1000 different databases 80 to find its F closest databases 84 and again use the distance or weighted distance between the E×P matrix of LPCC of the unknown sentence and the E×P matrices of LPCC of the similar known sentences in its F closest databases to find a known sentence to be the unknown sentence 90.

8. The invention provides a skill to help recognize unsuccessful sentences. If an unknown sentence is not identified, pronounce the unknown sentence again and put the new E×P matrix of LPCC of the unknown sentence into its closest database. It will successfully identify the unknown sentence.

9. The invention does not use samples, only use simple mathematics to compute the distances and hence the invention can immediately and accurately identify an unknown sentence in less than one second using Visual Basic. Any user without training can use the invention to freely communicate with a computer. The inventors use 1000 different English words as 1000 voices to denote 1000 databases. The inventors utter 928 sentences (80 English sentences, 284 Chinese sentences, 3 Taiwanese sentences, 2 Japanese sentences, 160 English words, 398 Chinese characters and 1 German word.) All sentences and English words are all identified as showed on the top 1 in a second using Visual Basic. The prior speech recognition methods have to compute and compare a series of feature values (matrices) of words for the whole sentence, but the invention only computes and compares one 12×12 matrix of LPCC. Chinese characters are identified as showed on top 1 or top 2 because many different Chinese characters have the same pronunciation. 7200 English words are pronounced and all are identified as showed on top 1 to top 5 in 2 seconds. 4400 Chinese characters are pronounced and all appear before top 20. 4400 Chinese characters are used to make a software program to input Chinese characters by the invention.

While the invention has been described in terms of preferred embodiments, those skilled in the art will recognize that the invention can be practiced with modifications within the spirit and scope of the appended claims.

What is claimed is:

1. A speech recognition method on sentences in all languages comprising:
(1) a sentence can be a syllable, a word, a name or a sentence, and M=1000 different voices are prepared;
(2) a pre-processor to delete noise and all time intervals without real signal sampled points, before and after a voice (sentence), between two syllables and two words;
(3) a method to normalize the whole waveform of real signal sampled points of a voice (sentence), using E equal elastic frames (windows) without filter and without overlap over each other, and to transform the whole waveform of real signal sampled points into an equal-sized E×P matrix of the linear predict coding cepstra (LPCC);
(4) M=1000 different voices are transformed into 1000 different E×P matrices of linear predict coding cepstra (LPCC) to represent 1000 different databases;
(5) a user pronounces a known sentence, delete noise and all time intervals without real language signal points, before and after the known sentence, between two syllables and two words, and E=12 equal elastic frames normalize the whole waveform of real language signal points into an E×P matrix of LPCC;
(6) use the distance or weighted distance between the E×P matrix of LPCC of the known sentence and 1000 different E×P matrices of LPCC of 1000 different voices representing 1000 different databases to find its closest database, the E×P matrix of the known sentence is put into its closest database, and similarly, the E×P matrices of LPCC of all known sentences are put into their closest databases individually;
(7) to classify an unknown sentence, after deletion of noise and time intervals without language signal points, before and after the unknown sentence, between two syllables and two words, the unknown sentence with real language sampled points is transformed into an E×P matrix of LPCC, the invention uses the distance or weighted distance between the E×P matrix of LPCC of the unknown sentence and 1000 different E×P matrices of LPCC of 1000 different voices representing 1000 different databases to find its F closest databases and again uses the distance or weighted distance between the E×P matrix of LPCC of the unknown sentence and the E×P matrices of LPCC of the similar known sentences in its F closest databases to find a known sentence to be the unknown sentence; and
(8) if an unknown sentence is not identified, the unknown sentence is pronounced again, its E×P matrix of LPCC is put into the new closest database, and then it will be identified correctly.

2. The speech recognition method on sentences in all languages of claim 1 wherein said step (2) further includes two methods to delete noise and time intervals without real signal sampled points, before and after a voice (sentence), between two syllables and two words:
(a) in a small unit time interval, compute the variance of sampled points in the unit time interval and if the variance is less than the variance of noise, delete the small unit time interval; and
(b) in a small unit time interval, compute the total sum of absolute distances between two consecutive sampled points and if the total sum of absolute distances is less than that of noise, delete the small unit time interval.

3. The speech recognition method on sentences in all languages of claim 1 wherein said step (3) further includes a method for normalization of the signal waveform of a voice or a sentence into an equal-sized E×P matrix of linear predict coding cepstra (LPCC) using E equal elastic frames (windows) without filter and without overlap over each other:
(a) a method is used to uniformly and equally partition the whole waveform of a voice or a sentence into E equal sections, the length of each equal section is proportional to the whole waveform of a sentence (voice) and each equal section forms an elastic frame (window) without filter and without overlap over each other such that E equal elastic frames can contract and expand themselves to cover the whole waveform;
(b) in each equal elastic frame, use a linear regression model to estimate the nonlinear time-varying waveform to produce a set of P=12 regression coefficients, i.e., 12 linear predict coding (LPC) coefficients by the least squares method;
(c) use Durbin's recursive equations
$$R ( i ) = {{\sum }_{n = 0}}^{N - i} S ( n ) S ( n + i ) , i \geq 0$$
$$\begin{matrix}{E}_{0} = R ( 0 ) \\ {k}_{i} = [ R ( i ) - {\sum }_{j = 1}^{i - 1} {a}_{j}^{( i - 1 )} R ( i - j ) ] / {E}_{i - 1} \\ {a}_{i}^{( i )} = {k}_{i} \\ {a}_{j}^{( i )} = {a}_{j}^{( i - 1 )} - {k}_{i} {a}_{i - j}^{( i - 1 )} , 1 \leq j \leq i - 1 \\ {E}_{i} = ( 1 - {k}_{i}^{2} ) {E}_{i - 1} \\ {a}_{j} = {a}_{j}^{( P )} , 1 \leq j \leq P\end{matrix}$$
to compute the P=12 least squares estimates aⱼ, 1≦i≦P called a linear predict coding (LPC) vector of dimension P and use the equations
$$\begin{matrix}{\hat{a}}_{i} = {a}_{i} + {\sum }_{j = 1}^{i - 1} ( \frac{j}{i} ) {a}_{i - j} {\hat{a}}_{j} , 1 \leq i \leq P \\ {\hat{a}}_{i} = {\sum }_{j = i - P}^{i - 1} ( \frac{j}{i} ) {a}_{i - j} {\hat{a}}_{j} , P < i\end{matrix}$$
to transform the LPC vector into the more stable linear predict coding cepstra (LPCC) vector âᵢ, 1≦i≦P;
(d) E=12 linear predict coding cepstra (LPCC) vectors, i.e., an E×P=12×12 matrix of LPCC, represents a voice or a sentence.
